(19) United States
(12) Patent Application Publication
(10) Pub. No.: US 2025/0030810 A1
(43) Pub. Date: Jan. 23, 2025

(54) COLOR MANAGEMENT FOR MACHINE-READABLE OPTICAL CODES ON PRINTED PRODUCTS

(71) Applicant: Heidelberger Druckmaschinen AG, Heidelberg (DE)

(72) Inventors: Stefan Schenk, Wiesenbach (DE); Hauke Thomsen, Heikendorf (DE)

(21) Appl. No.: 18/775,423

(22) Filed: Jul. 17, 2024

(30) Foreign Application Priority Data
Jul. 17, 2023 (DE) 10 2023 118 821.6

(51) Int. Cl. H04N 1/60

(52) U.S. Cl. CPC H04N 1/6008; H04N 1/6041

(57) ABSTRACT

A method prints a printed image containing at least one machine-readable optical code. During a color space transformation, the digital data of the code within the printed image are transformed according to a different method to the remainder of the printed image, with the number of printing colors of the code being reduced during the transformation.

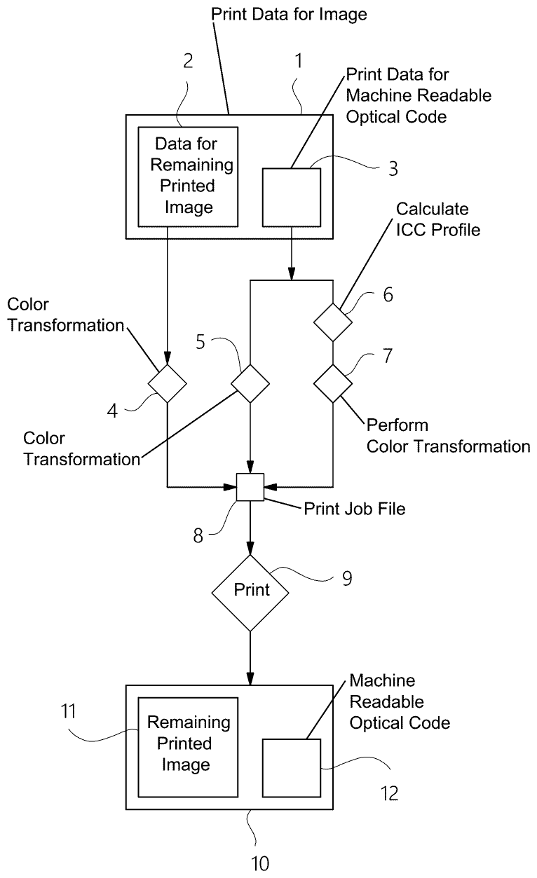

### CROSS-REFERENCE TO RELATED APPLICATION

This application claims the priority, under 35 U.S.C. § 119, of German Patent Application DE 10 2023 118 821.6, filed Jul. 17, 2023; the prior application is herewith incorporated by reference in its entirety.

### FIELD AND BACKGROUND OF THE INVENTION

The present invention relates to a method for printing a printed image containing at least one machine-readable optical code.

Various printing methods, such as offset printing, flexographic printing, screen printing, inkjet printing and many more, are known in the printing industry. The print job data for such printing methods are usually available in digital form and comprise, inter alia, information regarding the desired color reproduction of the printed image. However, without conversion, the color reproduction data for the printed image generally cannot be implemented by the printing machine because the printing machine has a different color space, for instance cyan, magenta, yellow, black (CMYK), in comparison with the digital data for the printed image. In the prior art, the conversion of the color information, also referred to as a color transformation, is frequently conducted in the prepress via ICC profiles.

A problem occurring especially when printing product packaging with barcodes or QR codes is that the quality of the barcodes and QR codes suffers following the color transformation. The readability thereof, for instance by way of till systems, is subsequently reduced. Label printing and packaging printing often uses spot colors which are subjected to color management. This often leads to color mixing, which is particularly susceptible to print register variations during printing. There additionally is an edge blur arising from the print points if the color mixture consists of relatively open halftones. This further reduces the readability of the barcodes and QR codes. Simple replacement of the color for the barcode or QR code with a high contrast color such as black is not always possible or desirable.

Non-prosecuted German patent application DE 10 2018 201 669 A1 discloses a method for preserving the black composition of objects. It describes a method containing a color space transformation with which it is possible to print black image objects such as barcodes on spot colors without adversely affecting the printing quality. It does not describe a separate color transformation of image data of the barcodes while reducing the number of their printing colors.

### SUMMARY OF THE INVENTION

It is the object of the present invention to specify a method with which printed images with machine-readable optical codes can be printed on printing machines, wherein the codes subsequently have improved optical readability.

In this context, it was found that a particularly good machine-readable optical code is obtained on the printing material if different methods are used for the color transformation of the digital print data for the code and the digital print data for the remaining printed image, with the number of printing colors of the code being reduced during the color transformation.

The method according to the invention is linked to a number of advantages. It is possible to obtain an increase in the contour accuracy and hence in the readability of the code by a deliberate selection of a color with a high area covering proportion. A very sharp edge of the codes can be obtained. At the same time, the print register susceptibility can be reduced due to the reduced use of primary colors. The codes obtained by the method according to the invention can be optically identified and read by machine with a reduced error rate.

Accordingly, the present invention relates to a method for printing, by way of a printing machine, a printed image containing at least one machine-readable optical code, in which digital print data for the printed image are provided. The digital print data for the printed image contains the digital print data for the at least one machine-readable optical code and the digital print data for the remaining printed image. The digital print data for the printed image being subject to a color transformation containing the transformation of the colors in the printed image to the printing colors of the printing machine, with the digital print data for the printed image subjected to the color transformation being transmitted to the printing machine and being used to print the printed image using the printing machine. Wherein during the color transformation of the digital print data for the printed image, the digital print data for the at least one machine-readable optical code are transformed using a different method to the digital print data for the remaining printed image, and the number of printing colors for the at least one machine-readable optical code are reduced in the digital print data for the at least one machine-readable optical code.

A machine-readable optical code in printed form is understood to mean a printed image on a printing material, wherein the printed image encodes information which can be optically captured by means of a machine-type optical apparatus, by preference an electronic scanner such as a till scanner, an electronic handheld scanner or a smartphone, and which can be read out by means of a computer. In a preferred embodiment, the at least one machine-readable optical code is selected from barcodes and QR codes.

According to the invention, the digital data for the remaining printed image are understood to mean those image data which are subjected to a color transformation but do not comprise any image data for a machine-readable optical code. Thus, this is the pictorial representation of what is intended to be printed onto the printing material by the printing machine, without the pictorial representation of one or more machine-readable optical codes present in the original printed image.

Within the scope of the color transformation of the digital print data for the printed image in the method according to the invention, the digital print data for the at least one machine-readable optical code are transformed using a different method to the digital print data for the remaining printed image. Accordingly, the digital print data for the at least one machine-readable optical code are subject to a different color transformation to the digital print data for the remaining printed image. In particular, the digital print data for the remaining printed image are not subjected to a color transformation in which the number of printing colors for the remaining printed image are reduced.

In principle, all types of printing machines are suitable as printing machines for the method according to the invention. By preference, the printing machines are selected from offset printing machines, flexographic printing machines, screen printing machines and inkjet printing machines. These may be configured differently and, in this respect, have different target color spaces. Preferred printing machines for the method according to the invention are those which comprise the CMYK colors and optionally at least one spot color. Spot colors are understood to mean those colors that cannot be obtained by any desired mixing of the CMYK colors. For example, the at least one spot color can be a metallic color.

In principle, any printing material known to a person in the art as suitable for use in printing machines can be used as printing material in the method according to the invention. These can be present in the form of sheets or webs. Printing materials are preferably selected from among paper, cardboard and film.

Prior to the color transformation and within the digital print data for the printed image, the digital print data for the at least one machine-readable optical code are singled out vis-à-vis the digital print data for the remaining printed image using at least one digital marker in a preferred embodiment.

In a further preferred embodiment, the color transformation is conducted in a color management module of the prepress using ICC profiles. In a particularly preferred embodiment, the transformation rule for the color transformation is calculated before the color transformation is conducted, the transformation rule is stored in at least one ICC profile calculated in advance, and the color transformation is conducted using this at least one ICC profile calculated in advance. In a further particularly preferred embodiment, the transformation rule is calculated while the color transformation is conducted, the transformation rule is stored in at least one ICC profile, and the color transformation is conducted using this at least one ICC profile calculated during the color transformation.

According to the invention and during the color transformation of the digital print data for the printed image, the digital print data for the at least one machine-readable optical code are transformed according to a method in which the number of printing colors assigned to the at least one machine-readable optical code in the digital print data are reduced. In a preferred embodiment of the method according to the invention, the number of printing colors is reduced to only one color.

In a preferred embodiment, the digital print data for the at least one machine-readable optical code are transformed according to a method in which the digital print data for the at least one machine-readable optical code are assigned at least one printing color which has an increased area coverage. In this case, a printing color with an increased area coverage is understood to mean a printing color whose area coverage is increased in comparison with the specified printing colors without the color transformation according to the invention. A particularly good contour reproduction of the machine-readable optical codes and hence particularly good readability are obtained as a result of the objectives of using as few printing colors as possible from the available color storage of the printing machine for the at least one machine-readable optical code and of simultaneously using at least one color with a high area coverage.

In a further preferred embodiment, the digital print data for the at least one machine-readable optical code are transformed according to a method in which the digital print data for the at least one machine-readable optical code are assigned at least one printing color which has an increased contrast. In this case, a printing color with an increased contrast is understood to mean a printing color whose contrast is increased in comparison with the specified printing colors without the color transformation according to the invention.

In a further preferred embodiment, the color impression of the at least one machine-readable optical code is made to approximate the color impression of the remaining printed image to the greatest extent possible during the color transformation of the digital print data for the printed image. For example, when printing a packaging with a barcode, the packaging may have large areas of the same hue, for instance a green hue, in the remaining printed image. The barcode itself should then be printed in the same green hue where possible, but according to the invention with a reduced number of printing colors. Then, a color combination with a reduced number of printing colors which, within the scope of the color mixing, largely corresponds to the color impression of the green hue areas in the remaining printed image is selected during the color transformation of the print data for the barcode.

The printed images obtained according to the method according to the invention can be printed onto different printing materials for the purpose of producing different printed products. In a preferred embodiment, the printed image is selected from printed images for product packaging with one or more barcodes, preferably product packaging for foodstuffs, cosmetics or other consumables.

In a preferred embodiment, the method according to the invention can be conducted as explained below. The digital print data for the printed image are supplied to the color management module (CMM) of the prepress with a digital marker for the digital print data for the at least one machine-readable optical code. A special color management is implemented on the basis of this digital marker, within the scope of which i) a minimized number of printing colors is used for the color composition of the code and ii) care is taken that a sufficiently high contrast color with a high area proportion is used as primary color. The high area proportion can be dependent both on half tone and hue value increase since in the print the area should largely become a continuous tone area with small edge modulations, and iii) the admissible color deviation is adapted where necessary in order to better attain the formulated object according to points i) and ii) since the machine-readable optical codes are free-standing and hence not large areas, meaning that direct color comparison by the human eye is limited.

In a further preferred embodiment, the method according to the invention can be conducted as explained below. The machine-readable optical codes or the colors for the machine-readable optical codes are labeled in the document preparation of the prepress and transmitted to the color management module (CMM) with an appropriate tag. The color to be reproduced is purposefully treated in the color management in respect of the readability of the machine-readable optical code, wherein a sufficiently high contrast primary color is used as a base color with a sufficiently high area proportion, and the number of additionally used primary colors is reduced to a minimum without dropping below a certain quality threshold in terms of color difference. The color management module conducts a specific color transformation, which may deviate from the separation rule defined in the ICC profile, for an element labeled as a machine-readable optical code. In this respect, use is made of the characterization of the printing process specified in the ICC profile by A2Bx. This is used to optimize a color formula for the color impression of the element to be reproduced, wherein properties of the separations linked to the machine readability of the element are also taken into account, in addition to the colorimetric difference between input and printout. In contrast to the general separation rule of the ICC profile, significant changes in the separations may occur here for two similar input color locations since paths are not intended to be separated here, with the result that the optimal separation can be used for each input color location independently from the surroundings. In the case of the method described here, the aforementioned special separation for the input color location of an element can be calculated directly during the initialization of the color transformation for the print job. Thus, the separation is optimized only for exactly the one input color location used in the element. Alternatively, the special separation is calculated in tabular form for the entire input color space during a preparatory phase which may take place directly during the generation of the ICC profile for the output process. This table can also be stored in the created ICC profile as a further transformation rule. The special separation rule can likewise be stored as a separation tag in a second ICC profile, wherein this second profile is only intended to be used for the separation of elements labeled as machine-readable optical codes. During the use of the tabulated transformation rules for the labeled machine-readable elements, the color management module is put into a specific interpolation mode in which the separation of exactly one grid point of the table is used for each input color location to be interpolated. This interpolation mode ensures that a separation with disadvantageous properties does not arise as a result of combining two optimized separations, even in the case of input color locations not coinciding with a grid point in the table. A device link profile can be calculated with the aid of the non-modified ICC profile for the output process and the separation rule optimized for machine-readable elements. The application thereof results in the creation of a separation which is optimized for machine readability from a conventional separation. When applying this device link profile, too, the color management module should preferably use an interpolation mode in which the separation is output at exactly one grid point. Alternatively, it is possible to create a device link profile with high resolution step-shaped input lookup tables (LUT), such that each CMYK tuple composed of 8-bit values lands on exactly one grid point of the four-dimensional CLUT following the application of the input LUT. The described method can be supplemented with an assessment unit in a workflow system. This assessment unit simulates the output of a machine-readable element and assesses the machine readability of the element on the basis of a soft proof, for example on the basis of the specifications in the ISO 15415 standard. This may still take place prior to the output of the print job, and so the printer can use this information to decide whether further adaptations should be carried out prior to the output.

Other features which are considered as characteristic for the invention are set forth in the appended claims.

Although the invention is illustrated and described herein as embodied in a color management for machine-readable optical codes on printed products, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

The single figure of the drawing is an illustration showing a procedure of a preferred embodiment of the method according to the invention.

### DETAILED DESCRIPTION OF THE INVENTION

Referring now to the single figure of the drawing in detail, there is shown print data for an entire printed image 1 being available in a prepress in digital form. The print data for the entire printed image 1 comprise the digital print data for the machine-readable optical code 3 and the print data for the remaining printed image 2 without code. The print data of the code 3 are color transformed 5 in a color management module of the prepress using an ICC profile calculated directly during the color transformation, with the number of printing colors used for the code being reduced. Alternatively, the ICC profile for the color transformation is calculated in advance 6 in an intermediate step and the color transformation of the code is then conducted 7 using the ICC profile calculated in advance, with the number of printing colors used for the code being reduced. The print data for the remaining printed image 2 are subjected to a conventional color transformation 4. The print data obtained following the color transformation are stored in a file 8 containing all of the data of the print job for the printing machine. The file 8 is transmitted to the printing machine and the entire printed image 1 containing the print data for the code 3 and for the remaining printed image 2 is printed 9. As a result, a printed print sheet 10 with the printed code 12 and the printed remaining printed image 11 is obtained. As a result of the specific color transformation for the code 3, the latter is optically readable in particularly advantageous fashion.

The following is a summary list of reference numerals and the corresponding structure used in the above description of the invention:
1 Digital print data for the printed image
2 Digital print data for the remaining printed image
3 Digital print data for the machine-readable optical code
4 Color transformation of the digital print data for the remaining printed image using an ICC profile
5 Color transformation of the digital print data for the machine-readable optical code using an ICC profile calculated during the color transformation
6 Advance calculation of the ICC profile for the color transformation of the machine-readable optical code
7 Color transformation of the digital print data for the machine-readable optical code using the ICC profile calculated in advance
8 Print job file
9 Printing the print job using the printing machine
10 Print sheet
11 Printed remaining printed image
12 Printed machine-readable optical code

1. A method for printing, by way of a printing machine, a printed image containing at least one machine-readable optical code, in which digital print data for the printed image are provided, the digital print data for the printed image containing the digital print data for the at least one machine-readable optical code and the digital print data for a remaining printed image, which comprises the steps of:
subjecting the digital print data for the printed image to a color transformation including a transformation of colors in the printed image to printing colors of the printing machine, during the color transformation of the digital print data for the printed image, the digital print data for the at least one machine-readable optical code are transformed using a different method to the digital print data for the remaining printed image, and a number of the printing colors for the at least one machine-readable optical code are reduced in the digital print data for the at least one machine-readable optical code; and
transmitting the digital print data for the printed image subjected to the color transformation to the printing machine and being used to print the printed image using the printing machine.

2. The method according to claim 1, wherein the at least one machine-readable optical code is selected from barcodes and quick response (QR) codes.

3. The method according to claim 1, wherein prior to the color transformation and within the digital print data for the printed image, the digital print data for the at least one machine-readable optical code are singled out vis-à-vis the digital print data for the remaining printed image using at least one digital marker.

4. The method according to claim 1, which further comprises conducting the color transformation in a color management module of a prepress using International Color Consortium (ICC) profiles.

5. The method according to claim 4, which further comprises calculating a transformation rule for the color transformation before the color transformation is conducted and stored in at least one said ICC profile, and the color transformation is conducted using the at least one ICC profile calculated in advance.

6. The method according to claim 4, which further comprises calculating a transformation rule for the color transformation while the color transformation is conducted and stored in at least one said ICC profile, and the color transformation is conducted using the at least one ICC profile calculated during the color transformation.

7. The method according to claim 1, wherein within a scope of the color transformation of the digital print data for the printed image, the digital print data for the at least one machine-readable optical code are transformed according to a method in which the digital print data for the at least one machine-readable optical code are assigned at least one printing color which has an increased area coverage.

8. The method according to claim 1, wherein within a scope of the color transformation of the digital print data for the printed image, the digital print data for the at least one machine-readable optical code are transformed according to a method in which the digital print data for the at least one machine-readable optical code are assigned at least one printing color which has an increased contrast.

9. The method according to claim 1, wherein within a scope of the color transformation of the digital print data for the printed image, the digital print data for the at least one machine-readable optical code are transformed according to a method in which the digital print data for the at least one machine-readable optical code are assigned at least one printing color, as a result of which a color impression of the at least one machine-readable optical code is made to approximate the color impression of the remaining printed image to the greatest extent possible.

10. The method according to claim 1, which further comprises selecting the printed image from printed images for product packaging with at least one barcode.
